(19) United States
(12) Patent Application Publication
(10) Pub. No.: US 2026/0056689 A1
(43) Pub. Date: Feb. 26, 2026

(54) SYSTEM AND METHOD

(71) Applicant: CANON KABUSHIKI KAISHA, Tokyo (JP)

(72) Inventor: MITSUHIDE SATAKE, Kanagawa (JP)

(21) Appl. No.: 19/269,203

(22) Filed: Jul. 15, 2025

(30) Foreign Application Priority Data
Aug. 21, 2024 (JP) 2024-140057

(51) Int. Cl. G06F 3/12

(52) U.S. Cl. CPC G06F 3/123; G06F 3/1204; G06F 3/1285

(57) ABSTRACT

A system is provided that includes an image processing apparatus and a distribution management server configured to manage distribution of firmware operating on the image processing apparatus. The image processing apparatus includes a first memory storing first instructions, and a first processor executing the stored first instructions, causing the image processing apparatus to distribute distribution target firmware instructed by distribution instruction information from the image processing apparatus to the image processing apparatus. The distribution management server includes a second memory storing second instructions, and a second processor executing the stored second instructions, causing the distribution management server to acquire information on firmware installed in the image processing apparatus, and to update, without receiving an update result of distribution target firmware instructed by the distribution instruction information from the image processing apparatus and based on whether or not information on the installed firmware corresponds to information on distribution target firmware instructed by the distribution instruction information, a distribution status serving as a distribution result of distribution target firmware instructed by the distribution instruction information.

### BACKGROUND

### Field of the Technology

The present disclosure relates to a system and a method, and more particularly, to a system including an image processing apparatus and a distribution management server, and a control method therefor.

### Description of the Related Art

Conventionally, in a case in which firmware of an image forming apparatus such as a printer, a multifunction peripheral, and the like needs to be updated due to a version upgrade, a failure, and the like, a service engineer visits the user site and manually performs the firmware update. Accordingly, maintenance costs associated with firmware updates have been high.

In recent years, a technique has been proposed in which firmware is stored in a rewritable storage device such as a flash memory, and a firmware update is performed by transmitting firmware via the Internet.

Japanese Patent Application Laid-Open No. 2012-059180 discloses a system for issuing an instruction to update firmware of an image forming apparatus remotely. A distribution management server that performs distribution control issues instructions specifying a download time, an installation time, and the like to a plurality of image forming apparatuses. Each image forming apparatus, upon receiving the instruction, downloads the firmware from the distribution management server at the designated time and updates firmware of the image forming apparatus using the downloaded firmware.

In such a case, a manufacturer of the image forming apparatus or a service provider that provides a device management service wants to confirm the result of a firmware update from a remote location. However, after the firmware has been distributed, the image forming apparatus to which the firmware has been applied may be an apparatus that does not transmit a distribution result, or a drawback such as a communication failure may occur during transmission of the distribution result. In such a case, a problem arises in that confirmation of the result of the update of firmware at a remote location is difficult.

### SUMMARY

The present disclosure is directed to enabling confirmation of a firmware update result at a remote location.

A system according to one embodiment of the present disclosure includes an image processing apparatus and a distribution management server configured to manage distribution of firmware operating on the image processing apparatus, the image processing apparatus comprising a first memory storing first instructions; and a first processor executing the stored first instructions causing the image processing apparatus to distribute distribution target firmware instructed by distribution instruction information from the image processing apparatus to the image processing apparatus, the distribution management server comprising a second memory storing second instructions, and a second processor executing the stored second instructions causing the distribution management server to acquire information on firmware installed in the image processing apparatus, and to update, without receiving an update result of distribution target firmware instructed by the distribution instruction information from the image processing apparatus and based on whether or not information on the installed firmware corresponds to information on distribution target firmware instructed by the distribution instruction information, a distribution status serving as a distribution result of distribution target firmware instructed by the distribution instruction information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a system configuration according to a first embodiment of the present disclosure.

FIG. 2 is a diagram illustrating a hardware configuration of a distribution management server 101, a content server 102, and a client PC 104.

FIG. 3 is a diagram illustrating a hardware configuration of an image forming apparatus 103.

FIG. 4 is a block diagram of the distribution management server 101.

FIG. 5 is a block diagram of the content server 102.

FIG. 6 is a block diagram of the image forming apparatus 103.

FIG. 7 is a sequence diagram illustrating firmware registration.

FIG. 8 is a sequence diagram illustrating a case in which a distribution instruction is registered from a client PC 104.

FIG. 9 is a sequence diagram illustrating a case in which a distribution instruction is registered from the image forming apparatus 103.

FIG. 10 is a sequence diagram illustrating the firmware distribution sequence from download to installation, according to the first embodiment of the present disclosure.

FIG. 11 is a flowchart illustrating processing of a result determination unit 409 according to the first embodiment of the present disclosure.

FIG. 12 is a sequence diagram illustrating the firmware distribution sequence from download to installation, according to the second embodiment of the present disclosure.

FIG. 13 is a flowchart illustrating processing of the result determination unit 409 according to the second embodiment of the present disclosure.

FIG. 14 is a flowchart illustrating processing of the result determination unit 409 according to the third embodiment of the present disclosure.

FIG. 15 is a diagram illustrating a sequence performed by a status confirmation unit 405 according to the third embodiment of the present disclosure.

FIG. 16 is a diagram illustrating a sequence performed by a report generation unit 406 according to the third embodiment of the present disclosure.

### DESCRIPTION OF THE EMBODIMENTS

Hereinafter, embodiments of the present disclosure will be explained with reference to the drawings. However, the present disclosure is not limited to the embodiments to be explained below. Additionally, the embodiments to be explained below do not limit the present disclosure as defined in the claims, and not all combinations of features explained in the embodiments are necessarily essential to the solutions of the present disclosure. It should be noted that, in each drawing, the same members or elements are denoted by the same reference numerals, and redundant description will be omitted or simplified.

### First Embodiment

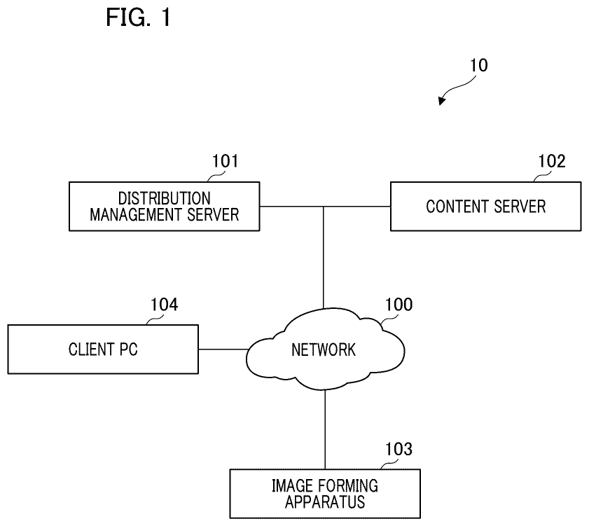

FIG. 1 is a block diagram illustrating a system configuration according to a first embodiment of the present disclosure. A system 10 according to the first embodiment is configured by mutually connecting a distribution management server 101, a content server 102, an image forming apparatus 103, and a client PC 104 via a network 100. The image forming apparatus 103 is an example of an image processing apparatus. The system 10 may include a plurality of distribution management servers 101, content servers 102, image forming apparatuses 103, and client PCs 104.

The distribution management server 101 can manage distribution information set by a service engineer and a customer. Additionally, the distribution management server 101 can confirm the distribution information via UI, and can confirm a distribution result with respect to the image forming apparatus 103. UI is an abbreviation for “User Interface”. Furthermore, the distribution management server 101 enables firmware to be registered and managed by a user. The distribution management server 101 manages distribution of firmware that operates on the image forming apparatus 103.

The content server 102 holds firmware corresponding to firmware that is managed by the distribution management server 101. The content server 102 responds to a request from the image forming apparatus 103 by providing the firmware, thereby allowing the image forming apparatus 103 to download the firmware. Although, in the present embodiment, the distribution management server 101 and the content server 102 are provided as separate servers, both functions may be provided by a single server.

The image forming apparatus 103 is, for example, an MFP. MFP is an abbreviation for “Multifunction Peripheral”. The image forming apparatus 103 can download and install firmware by communicating with the distribution management server 101 and the content server 102.

The client PC 104 is a PC operated by a user. PC is an abbreviation for “Personal Computer”. The user can perform operations via the client PC 104 to register firmware and distribute the firmware to the image forming apparatus 103.

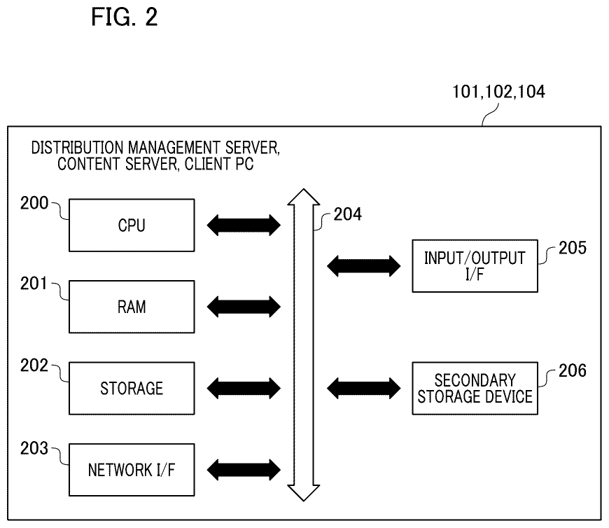

FIG. 2 is a hardware configuration diagram of the distribution management server 101, the content server 102, and the client PC 104. Reference numeral 201 denotes RAM as a volatile memory area. RAM is an abbreviation for “Random Access Memory”. Reference numeral 202 denotes a storage that stores embedded programs and data.

Reference numeral 203 denotes a network interface, and the network interface connects to the network 100 and performs communication with other computers and network devices. The communication may be either wired or wireless. Additionally, a mobile network interface may also be provided.

Reference numeral 205 denotes an input/output interface that may perform input and output of information and signals via a display, keyboard, mouse, touch panel, buttons, and the like. A computer that does not include such hardware may also be connected to and operated from another computer via a remote desktop, remote shell, and the like.

Reference numeral 206 denotes a secondary storage device such as an HDD or a flash memory. Reference numeral 200 denotes a CPU that executes programs read from the RAM 201, the storage 202, the secondary storage device 206, and the like. CPU is an abbreviation for “Central Processing Unit”. Each component is connected via a system bus 204. In the present embodiment, unless otherwise specified, the system bus 204 is assumed to propagate control commands from the CPU 200 to each hardware component that is connected to the system bus 204.

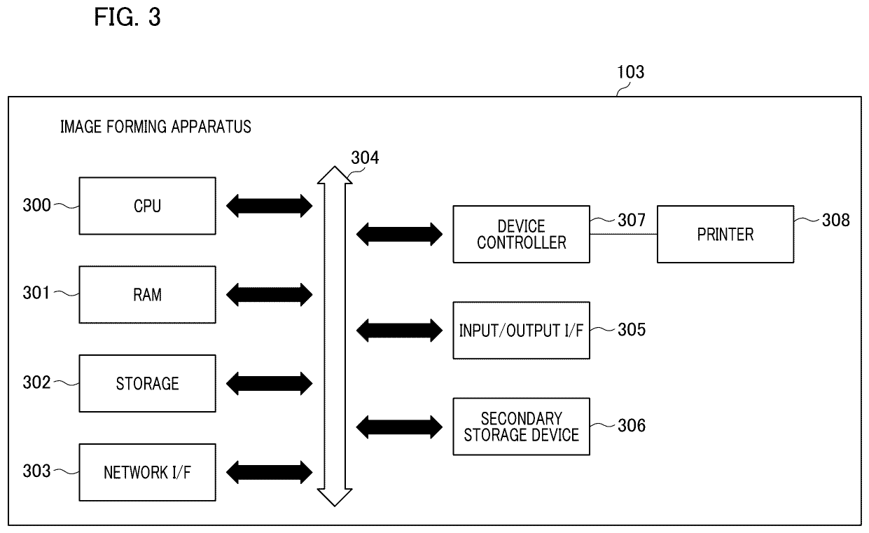

FIG. 3 is a hardware configuration diagram of the image forming apparatus 103. Reference numeral 301 denotes RAM as a volatile memory area. Reference numeral 302 denotes a storage in which embedded programs and data are stored. Reference numeral 303 denotes a network interface that is connected to a network and performs communication with other computers and network devices. The communication may be either wired or wireless. Additionally, a mobile network interface may also be provided.

Reference numeral 305 denotes an input/output interface that performs input and output of information and signals via a touch panel or buttons. A device that does not include such hardware may be connected and operated from another computer via a remote interface and the like.

Reference numeral 306 denotes a secondary storage device such as an HDD or flash memory. HDD is an abbreviation for “Hard Disk Drive”. Reference numeral 300 denotes a CPU that executes programs read from the RAM 301, the storage 302, the secondary storage device 306, and the like.

Reference numeral 308 denotes a printer that executes jobs such as printing. Reference numeral 307 denotes a device controller that receives control commands from the CPU 300 and controls the printer 308. Each component is connected via a system bus 304. In the present embodiment, unless otherwise specified, the system bus 304 is assumed to propagate control commands from the CPU 300 to each hardware component that is connected to the system bus 304.

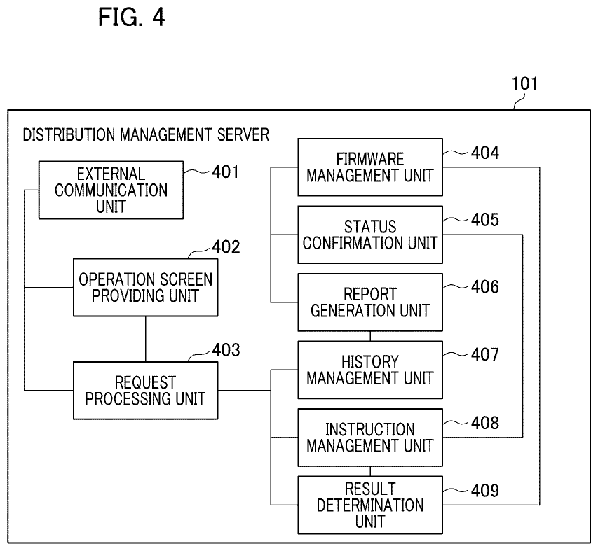

FIG. 4 is a block diagram illustrating an example of the software configuration of the distribution management server 101. Each component illustrated in FIG. 4 is realized by execution, by the CPU 200, of a program of the distribution management server 101 read from the RAM 201, the storage 202, the secondary storage device 206, and the like. Access from the distribution management server 101 to an external device, such as the content server 102, is performed via the network interface 203.

The distribution management server 101 can accept registration of a firmware file by using a firmware management unit 404 via a UI and the like provided by an operation screen providing unit 402, wherein the UI is operated from a client PC 104 by a user such as firmware registration personnel and the like. The accepted firmware file is transmitted to the content server 102 by an external communication unit 401. In addition, a firmware management unit 404 holds firmware management information corresponding to the firmware file by creating the firmware management information.

The distribution management server 101 can receive distribution instruction via, for example, a UI that is provided by the operation screen providing unit 402, which is operated by a user, such as a distribution instruction administrator, using the client PC 104. A request processing unit 403 receives the distribution instruction, generates distribution instruction information, and holds it in an instruction management unit 408. The distribution management server 101 can also process communication from the image forming apparatus 103 via the request processing unit 403 and proceed with the distribution.

The distribution management server 101 can determine the result of distribution using the result determination unit 409 and confirm the latest distribution instruction information for each image forming apparatus 103 using the status confirmation unit 405. Additionally, the report generation unit 406 can perform generation of a report using the distribution instruction information that is held in the instruction management unit 408 and the distribution history information that is held in a history management unit 407.

The history management unit 407 holds distribution history information generated by the request processing unit 403. The instruction management unit 408 holds distribution instruction information generated by the request processing unit 403. Additionally, the instruction management unit 408 holds version information on respective components of the firmware installed in the image forming apparatus 103, wherein the version information is transmitted by a notification unit 608 of the image forming apparatus 103.

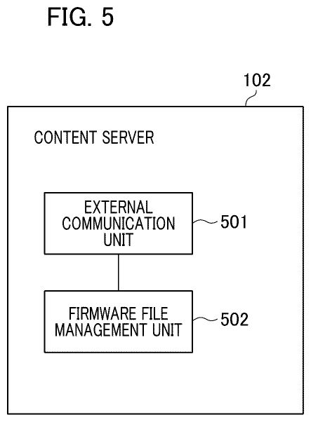

FIG. 5 is a block diagram illustrating an example of a software configuration of the content server 102. Each component illustrated in FIG. 5 is realized by the CPU 200 executing a program of the content server 102 read from the RAM 201, the storage 202, the secondary storage device 206, and the like. Access from the content server 102 to an external device, such as the distribution management server 101 or the image forming apparatus 103 and the like, is performed via the network interface 203.

In the content server 102, a firmware file transmitted by the distribution management server 101 is received by an external communication unit 501. A firmware file management unit 502 holds the firmware file received by the external communication unit 501 and issues a URL for accessing the firmware file. URL is an abbreviation for “Uniform Resource Locator”. Accordingly, the image forming apparatus 103 can access the URL issued by the firmware file management unit 502 and download the firmware file. The URL for accessing the firmware file held by the firmware file management unit 502 is also referred to as a “link to the firmware file”.

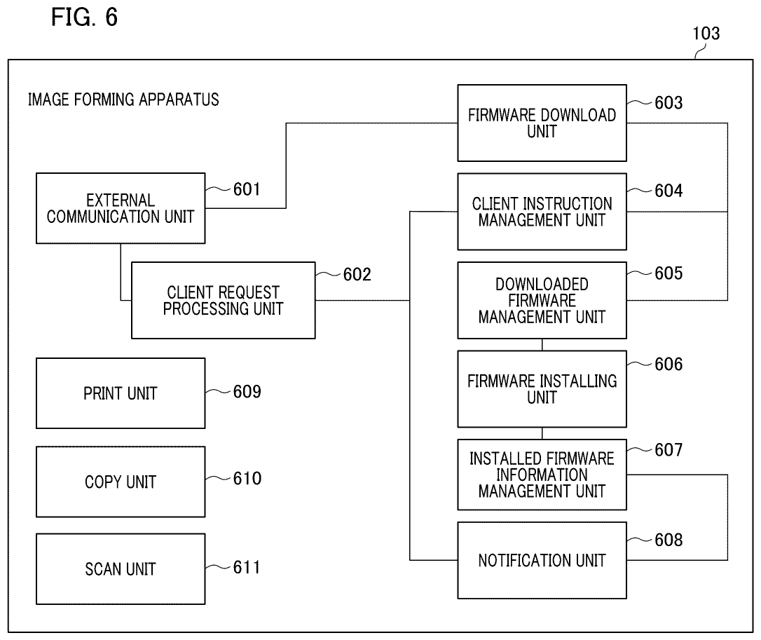

FIG. 6 is a block diagram illustrating an example of a software configuration of the image forming apparatus 103. Each component illustrated in FIG. 6 is realized by the CPU 300 executing a program of the image forming apparatus 103 read from the RAM 301, the storage 302, the secondary storage device 306, and the like. Access from the image forming apparatus 103 to an external device such as the distribution management server 101 is performed via the network interface 303. The image forming apparatus 103 is provided with a print unit 609, a copy unit 610, and a scan unit 611.

A client request processing unit 602 performs processing related to distribution with the distribution management server 101 via an external communication unit 601. The client request processing unit 602 acquires, as necessary, distribution instruction information held in the image forming apparatus 103 from a client instruction management unit 604 and uses the acquired information.

A firmware download unit 603 performs download of firmware by communicating with the distribution management server 101 and the content server 102 via the external communication unit 601. The downloaded firmware is held in a downloaded firmware management unit 605.

A firmware installing unit 606 installs the firmware held in the downloaded firmware management unit 605. Version information on each component of the firmware for which installation has been completed is held in an installed firmware information management unit 607.

The notification unit 608 provides, to the distribution management server 101, a notification of current version notification information including version information on each component of the firmware installed in the image forming apparatus 103, wherein the version information is held in the installed firmware information management unit 607.

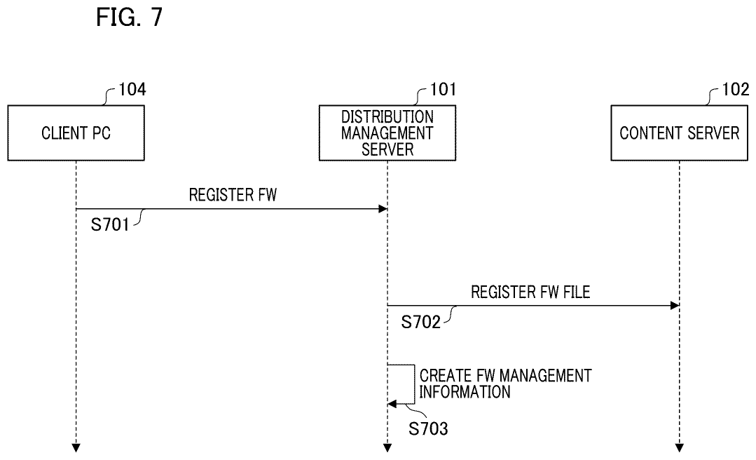

FIG. 7 is a diagram illustrating a flow until the firmware is registered. In this context, in FIG. 7, the firmware is abbreviated as “FW”. The same applies to the following drawings. The flow in FIG. 7 is executed by the client PC 104 operated by the user, starting from a firmware registration operation performed via the operation screen providing unit 402 provided by the distribution management server 101.

In step S701, the distribution management server 101 receives a registration of firmware by a user who is operating the client PC 104. The firmware file to be registered here may be a single file, or may be a file obtained by compressing files for individual components in a zip file format and the like. Here, the distribution management server 101 determines whether or not the format of the registered firmware is a predetermined format, and, in a case in which the format is an unintended format, the registration may be treated as a failure. Additionally, the distribution management server 101 may confirm whether or not a virus is included in the registered firmware and may treat the registration as a failure in a case in which a virus is detected.

In step S702, the distribution management server 101 transmits the received firmware file to the content server 102 via the external communication unit 401 of the distribution management server 101. At this time, the content server 102 holds the transmitted firmware file in the firmware file management unit 502 and issues a URL that enables external access to the firmware file.

In step S703, the distribution management server 101 causes the firmware management unit 404 to generate firmware management information corresponding to the firmware file, and holds the generated firmware management information in the firmware management unit 404 of the distribution management server 101.

The firmware management information includes the following information.
Firmware ID
Firmware version
Firmware component information
   Hereinafter, each piece of information included in the firmware management information will be explained.

The firmware ID is an ID for uniquely identifying the registered firmware. The firmware ID may be used when identifying the target firmware in distribution instruction information to be described below. The firmware version is a version of the firmware.

The component information on the firmware is information indicating the type and version of each component included in the firmware. The firmware may include a plurality of components, and the version of the firmware may be determined based on a combination of respective versions of the components. Naturally, in the case in which the firmware is configured by a single component, it suffices to indicate only the version of that single component. The component information on the firmware may be handled in, for example, the following dictionary format.

```
{
  “firmwareComponentMap”: {
    “componentA”: “1.0”,
      “componentB”: “1.0”,
      “componentC”: “1.0”
  }
}
```

In this case, the firmware is shown to be composed of version 1.0 of component A, version 1.0 of component B, and version 1.0 of component C. After the processing of step S703 is performed, the registered firmware can be distributed to the image forming apparatus 103.

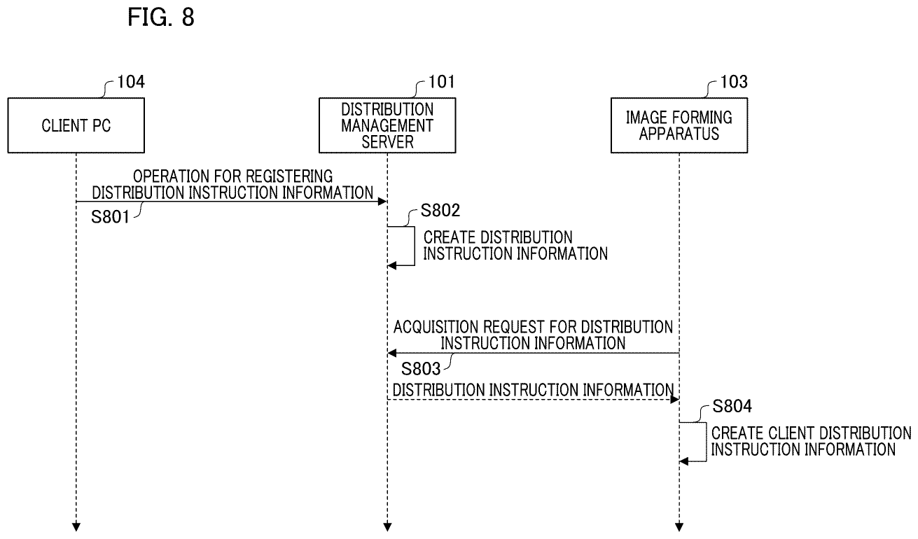

FIG. 8 illustrates a flow from a point in time when the user remotely issues a distribution instruction to a point in time when a notification of the distribution instruction is provided to the image forming apparatus 103. It is assumed that the flow of FIG. 8 is executed after firmware to be distributed has been registered in the distribution management server 101 by the flow of FIG. 7. The flow of FIG. 8 is executed when the client PC 104 operated by the user initiates a registration operation of distribution instruction information provided by the distribution management server 101 via the operation screen providing unit 402.

In step S801, the distribution management server 101 receives a distribution instruction, namely, a registration operation of distribution instruction information, from the client PC 104 operated by the user. In step S802, the distribution management server 101 causes the request processing unit 403 to generate distribution instruction information and holds the generated distribution instruction information in the instruction management unit 408.

The distribution instruction information includes information such as the following:
Distribution ID
Distribution status
Distribution target firmware ID
Distribution target device ID
Generation method of distribution instruction information
Method of installation
Forced installation availability
Download execution time
Installation execution time
Distribution instruction information generation time
Distribution instruction information last update time
Error code
Information regarding firmware currently installed in the image forming apparatus Hereinafter, each piece of information included in this distribution instruction information will be explained.

The distribution ID is an ID that uniquely identifies the distribution instruction information. The distribution ID is used to identify the corresponding distribution instruction information during communication between the image forming apparatus 103 and the distribution management server 101. The distribution status is information indicating the current stage of the distribution. The distribution status transitions at the timing when communication occurs between the image forming apparatus 103 and the distribution management server 101.

The distribution target firmware ID is an ID that identifies firmware to be installed in the image forming apparatus 103. The distribution target firmware ID corresponds to the firmware ID of the firmware management information, and can be specified by the user.

The distribution target device ID is an ID that identifies a device that is a target for installation of the firmware identified by the distribution target firmware ID.

The generation method of the distribution instruction information is a description of the method of generating the distribution instruction information. The installation method is a description of a method of installing the firmware identified by the distribution target firmware ID. The forced installation availability is a description of whether the firmware identified by the distribution target device ID can be forcibly installed. The download execution time is a description of the execution time for downloading the firmware identified by the distribution target device ID. The installation execution time is a description of the execution time for installing the firmware identified by the distribution target firmware ID. The generation time of the distribution instruction information is a description of the time at which this distribution instruction information is generated. The last update time of the distribution instruction information is a description of the time at which the distribution instruction information is last updated. The error code is a description of an error code relating to the distribution instruction of the distribution instruction information. The information on the firmware currently installed in the image forming apparatus is information on the firmware currently installed in the device identified by the distribution target device ID.

After step S802, in step S803, the image forming apparatus 103 requests the distribution management server 101 to acquire distribution instruction information. The acquisition request of the distribution instruction information by the image forming apparatus 103 may be performed periodically so that the image forming apparatus 103 can acquire the registered distribution instruction information by repeatedly requesting the distribution instruction information from the distribution management server 101.

When the distribution management server 101 receives a distribution instruction information acquisition request from the image forming apparatus 103, the distribution management server 101 causes the request processing unit 403 to identify distribution instruction information having a distribution target device ID matching that of the image forming apparatus 103. The distribution management server 101 acquires the identified distribution instruction information from the instruction management unit 408 and transmits it to the image forming apparatus 103. Here, the distribution instruction information transmitted by the distribution management server 101 may use the distribution instruction information held by the distribution management server 101 as is, or may have unnecessary information for distribution, such as the generation time of the distribution instruction information, deleted.

In step S804, the image forming apparatus 103 that has received the distribution instruction information causes the request processing unit 403 to generate client distribution instruction information and holds the client distribution instruction information in the client instruction management unit 408. The client distribution instruction information is distribution instruction information held by the image forming apparatus 103, and the image forming apparatus 103 holds the client distribution instruction information for performing subsequent distribution processing. As the client distribution instruction information, the image forming apparatus 103 may use the distribution instruction information held by the instruction management unit 408 of the distribution management server 101 as is, or may delete unnecessary information such as the generation time of the distribution instruction information.

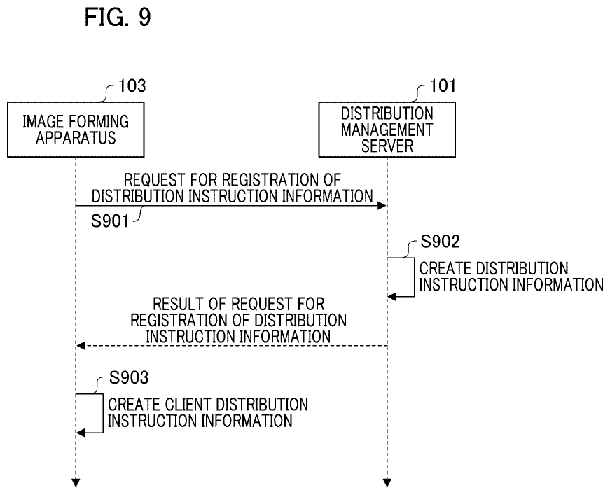

FIG. 9 illustrates a sequence in which a distribution instruction is issued from the image forming apparatus 103. The processing in FIG. 9 is assumed to be performed after firmware to be distributed has been registered in the distribution management server 101 according to the flow in FIG. 7.

In step S901, the image forming apparatus 103 requests the distribution management server 101 to register distribution instruction information. In step S902, the distribution management server 101 causes the request processing unit 403 to generate distribution instruction information and returns a registration request result of the distribution instruction information to the image forming apparatus 103.

The trigger for performing the processing in step S901 may be a timing at which a user such as a service engineer sets a distribution instruction via the input/output I/F 306 of the image forming apparatus 103. Additionally, in a case in which the client instruction management unit 604 of the image forming apparatus 103 sets client distribution instruction information for performing periodic update, the trigger may be the timing at which the update time set in the client distribution instruction information arrives.

In step S903, in a case in which the registration request result of the distribution instruction information returned in step S902 is a value indicating successful registration, the image forming apparatus 103 causes the request processing unit 403 to generate client distribution instruction information. The image forming apparatus 103 holds the generated client distribution instruction information in the client instruction management unit 604.

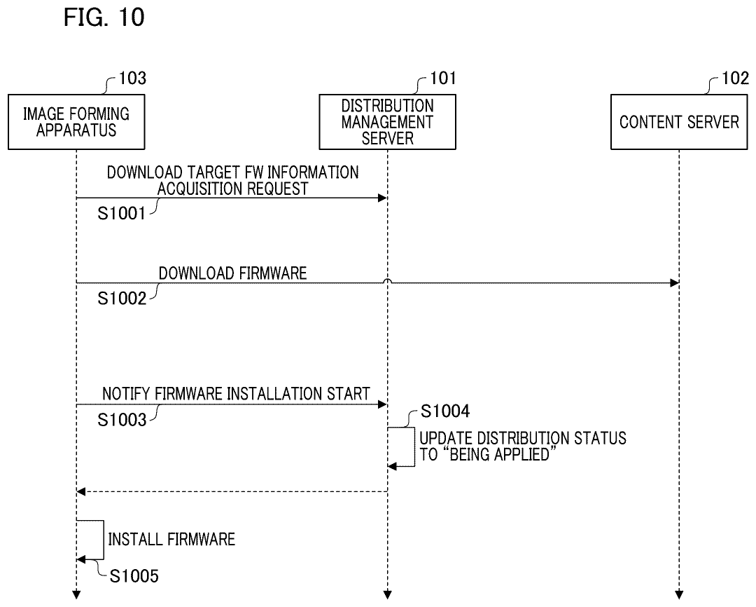

FIG. 10 is a diagram illustrating a distribution flow from downloading of firmware of the image forming apparatus 103 to installation of the firmware. The flow of FIG. 10 is executed when the download start time included in the client distribution instruction information held in the client instruction management unit 604 arrives.

In step S1001, the image forming apparatus 103 causes the client request processing unit 602 to perform a download target firmware information acquisition request to the distribution management server 101. At this time, the image forming apparatus 103 transmits, to the distribution management server 101, distribution instruction information including an ID for uniquely identifying the distribution instruction information, from among the distribution instruction information held in the client instruction management unit 604.

The distribution management server 101 causes the request processing unit 403 to acquire the corresponding distribution instruction information from the instruction management unit 408. The distribution management server 101 specifies the firmware to be downloaded to the image forming apparatus 103 from the firmware management unit 404, based on the distribution target firmware ID of the corresponding distribution instruction information. The distribution management server 101 acquires a link to the specified firmware file to be downloaded.

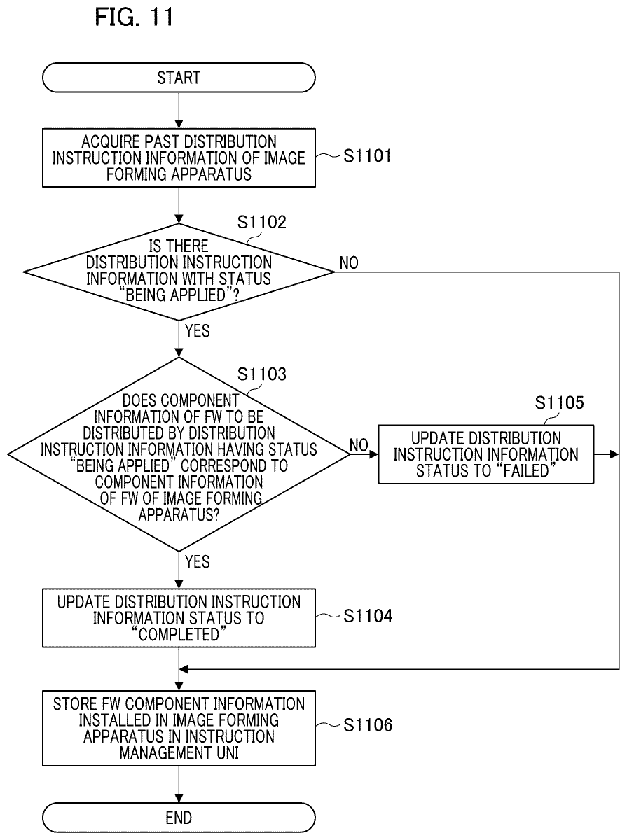

The distribution management server 101 may download only firmware that differs from the firmware to be distributed, based on information on a list of components and versions of firmware installed in the image forming apparatus 103. As a result, the number of pieces of firmware to be downloaded can be reduced. In the processing of FIG. 11 to be described below, the distribution management server 101 registers the list of components and versions of firmware already installed in the image forming apparatus 103 in the distribution instruction information. Then, the distribution management server 101 returns a link to the firmware file to be downloaded to the image forming apparatus 103.

In step S1002, the image forming apparatus 103 downloads the firmware by accessing the returned link to the firmware file. Here, the image forming apparatus 103 may notify the distribution management server 101 of completion of the download by sending a download completion notification after downloading the firmware. The distribution management server 101 that has received the download completion notification may cause the request processing unit 403 to update the distribution status of the distribution instruction information to a value such as “downloaded” and the like, indicating that the download has ended. This download of the firmware is an example of a distribution unit that distributes distribution target firmware instructed by the distribution instruction information, to the image forming apparatus 103.

After downloading the firmware, the image forming apparatus 103 performs installation of the firmware when the installation execution time included in the client distribution instruction information held by the client instruction management unit 604 is reached. In step S1003, the client request processing unit 602 notifies the distribution management server 101 of the start of firmware installation to the distribution management server 101 by performing communication with the distribution management server 101 via the external communication unit 601.

In step S1004, the distribution management server 101 causes the request processing unit 403 to update the distribution status of the corresponding distribution instruction information to a value such as “being applied” indicating that installation is in progress.

Thereafter, in step S1005, the image forming apparatus 103 installs the firmware file acquired by the firmware download unit 603 using the firmware installing unit 606.

FIG. 11 is a diagram illustrating a processing flow in the result determination unit 409. The flow in FIG. 11 is performed asynchronously with the distribution of firmware in FIG. 10. The image forming apparatus 103 transmits current version notification information to the distribution management server 101 using the notification unit 608. Upon receiving the current version notification information, the distribution management server 101 executes the result determination unit 409 via the request processing unit 403, and the flow in FIG. 11 is started. The transmission of the current version notification information by the notification unit 608 is repeatedly performed at a predetermined timing so that the state of the image forming apparatus 103 can be remotely managed. In the transmission of the current version notification information by the notification unit 608, information such as error information occurring in the image forming apparatus 103 and remaining amounts of consumables may also be notified together. The transmission of the current version notification information by the notification unit 608 may be performed when the image forming apparatus 103 is powered on, or may be performed periodically, for example, every six hours. The reception of the current version notification information by the distribution management server 101 is an example of an acquisition unit that acquires information on firmware already installed in the image forming apparatus 103.

The current version notification information includes the following information:
Device ID
Component information on currently installed firmware
   Hereinafter, each piece of information included in this current version notification information will be explained.

The device ID is an ID that identifies a device that notifies a firmware version by current version notification information. The component information on the currently installed firmware is a description of the component information on the firmware currently installed in the device identified by the device ID.

Hereinafter, an example of the current version notification information that is notified by the notification unit 608 will be described.

```
{
  “deviceId”: “1”,
  “installedFirmwareComponentMap”: {
    “componentA”: “2.0”,
    “componentB”: “1.0”,
    “componentC”: “1.0”,
    “componentD”: “1.0”
  }
}
```

In step S1101, the result determination unit 409 acquires, from among the distribution instruction information held in the instruction management unit 408, the distribution instruction information in which the distribution target device ID corresponds to the device ID included in the received current version notification information. In step S1102, the result determination unit 409 determines whether or not there is distribution instruction information having the distribution status “being applied” from among the acquired distribution instruction information. In a case in which the result determination unit 409 determines that there is distribution instruction information having the distribution status “being applied”, the processing of step S1103 is executed. In a case in which the result determination unit 409 determines that there is no distribution instruction information having the distribution status “being applied”, the processing of step S1106 is executed.

In step S1103, the result determination unit 409 acquires firmware management information corresponding to the distribution target firmware ID of the distribution instruction information, in a case in which there is distribution instruction information having the distribution status set to “being applied”. Furthermore, in step S1103, the result determination unit 409 compares the component information on the firmware in the firmware management information and the component information on the currently installed firmware in the received current version notification information and determines whether or not they correspond to each other. In a case in which the result determination unit 409 determines that the pieces of component information on the firmware correspond to each other, the processing of step S1104 is executed. In a case in which the result determination unit 409 determines that the pieces of component information on the firmware do not correspond, the processing of step S1105 is executed.

Note that, in step S1103, the correspondence between the pieces of component information on the firmware may mean that the types and versions of the components included in the respective pieces of component information completely match each other.

Note that, in step S1103, correspondence between the pieces of component information on the firmware may be defined as follows. For example, some firmware components included in the component information of the firmware downloaded from the distribution managing server 101 may be unnecessary depending on the type and state of the image forming apparatus 103, and may not be installed in some cases. Such a case may be regarded as a case in which the pieces of component information on the firmware correspond to each other. That is, a case in which firmware component information of firmware management information corresponding to distribution target firmware includes firmware component information of currently installed firmware of received current version notification information. An explanation is provided further below with respect to the case described above.
For example, it is assumed that the component information on the currently installed firmware in the current version notification information is as follows.

```
{
  “installedFirmwareComponentMap”: {
    “componentA”: “2.0”,
    “componentB”: “1.0”
  }
}
```

Additionally, it is assumed that the firmware component information on the firmware management information corresponding to the distribution target firmware ID to be compared is as follows.

```
{
  “firmwareComponentMap”: {
    “componentA”: “2.0”,
    “componentB”: “1.0”,
    “componentC”: “1.0”
  }
}
```

In this case, the pieces of component information on the firmware may correspond to each other.

Note that, in step S1103, the correspondence between the pieces of component information on the firmware may be defined as follows. For example, a case is considered in which component information other than the component information included in the firmware to be distributed this time has already been installed in the image forming apparatus 103 and is held in the installed firmware information management unit 607. The component information on the currently installed firmware in the received current version notification information may include the component information on the firmware in the firmware management information corresponding to the firmware to be distributed this time. In this case, the pieces of component information on the firmware may correspond to each other.
For example, it is assumed that the component information on the currently installed firmware in the current version notification information is as follows.

```
{
  “installedFirmwareComponentMap”: {
    “componentA”: “2.0”,
    “componentB”: “1.0”,
    “componentC”: “1.0”
  }
}
```

Additionally, it is assumed that the firmware component information on the firmware management information corresponding to the distribution target firmware ID to be compared is as follows.

```
{
  “firmwareComponentMap”: {
    “componentA”: “2.0”,
    “componentB”: “1.0”
  }
}
```

In this case, the pieces of component information on the firmware may correspond to each other.

Note that, in step S1103, a case in which the pieces of component information on the firmware correspond to each other may include a case in which a combination of the above-described conditions is satisfied.

In step S1104, the result determination unit 409 updates the distribution status of the distribution instruction information to “completed,” indicating completion of distribution. In step S1105, the result determination unit 409 updates the distribution status of the distribution instruction information to “failed,” indicating a distribution failure. Additionally, in step S1105, the result determination unit 409 may update the value of the error code included in the distribution instruction information to a value indicating that the distribution status has been determined to be “failed” by the result determination unit 409. In step S1106, the distribution management server 101 holds, in the instruction management unit 408, the component information on the currently installed firmware transmitted by the notification unit 608. Steps S1103, S1104, and S1105 are an example of an update unit that updates a distribution status serving as a distribution result of firmware to be distributed. Here, the update unit updates the distribution status based on whether or not the information on the firmware already installed in the image forming apparatus 103 corresponds to the information on the firmware to be distributed as instructed by the distribution instruction information. Additionally, in this context, the update unit updates the distribution status without receiving an update result of the firmware instructed by the distribution instruction information from the image forming apparatus 103.

As described above, according to the present embodiment, the distribution result can be determined even in a case in which the image forming apparatus, to which the firmware has been applied, does not transmit the distribution result, or in a case in which the image forming apparatus fails to notify the result due to some trouble.

### Second Embodiment

Next, a second embodiment of the present disclosure will be explained. In the second embodiment, only the portions that are different from the first embodiment are described. In the first embodiment, the image forming apparatus 103 does not have a function of notifying the installation result when the firmware is installed. The second embodiment is an example in which the image forming apparatus 103 has a function of notifying the installation result of the firmware when the firmware is installed.

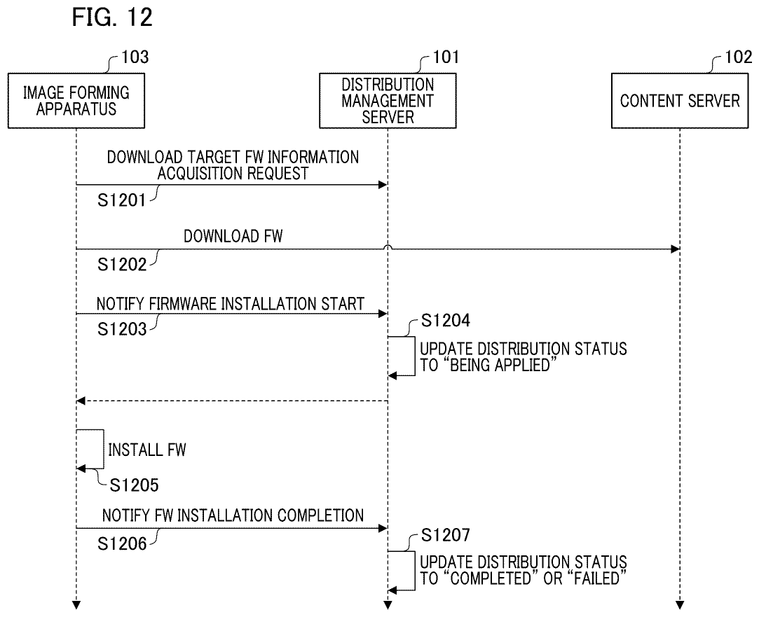

FIG. 12 is a sequence diagram illustrating the notification of the installation result to the distribution management server 101 by the client request processing unit 602 of the image forming apparatus 103 upon completion of the firmware installation. Since the processing from step S1201 to step S1205 is similar to the processing from step S1001 to step S1005 according to the first embodiment, an explanation thereof will be omitted.

After the installation of the firmware (step S1205), in step S1206, the image forming apparatus 103 causes the client request processing unit 602 to perform notification of completion of the installation to the distribution management server 101. The processing in step S1206 is an example of a notification unit that provides a notification of the installation result of the firmware distributed by the distribution unit to the distribution management server 101.

The installation completion notification information provided at the time of the installation completion notification includes the following information.
Distribution ID
Installation result information
Error code
   Hereinafter, each piece of information included in the installation completion notification information will be explained.

The distribution ID is an ID that uniquely identifies the distribution instruction information. The installation result information describes the installation result of the firmware specified by the distribution instruction information identified by the distribution ID. The error code is a description of an error code of a distribution instruction indicated by the distribution instruction information identified by the distribution ID.

In step S1207, the distribution management server 101 causes the request processing unit 403 to update the distribution status of the distribution instruction information corresponding to the distribution ID of the received installation completion notification information according to the value of the installation result information. For example, if the installation result information has a value indicating normal completion, the request processing unit 403 updates the distribution status of the distribution instruction information to “completed”. For example, if the installation result information has a value indicating abnormal termination, the request processing unit 403 updates the distribution status of the distribution instruction information to “failed” and updates the error code of the distribution instruction information with the received error code. The processing in step S1207 is an example of an update unit that updates the distribution status based on the installation result notified by the notification unit.

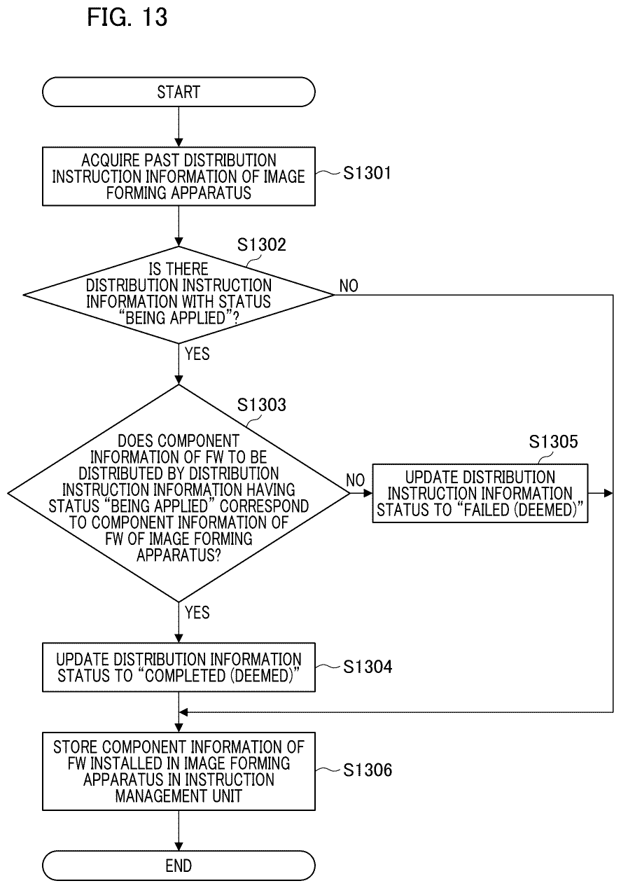

FIG. 13 is a diagram illustrating the processing flow of the result determination unit 409 of the distribution management server 101 according to the second embodiment. The flow of FIG. 13 is performed asynchronously with the firmware distribution of FIG. 12, similarly to the flow of FIG. 11 according to the first embodiment. The processing in steps S1301 to S1303 and step S1306 is the same as those in steps S1101 to S1103 and S1106 of the first embodiment, and thus a detailed explanation thereof will be omitted.

In step S1304, the result determination unit 409 updates the distribution status of the corresponding distribution instruction information to a value such as “completed (deemed).” Accordingly, it is possible to distinguish the distribution status from the case in which the installation result determination is performed on the device-side (step S1206). Naturally, if no distinction is necessary, the flow of FIG. 11 may be applied as is. In the example of FIG. 13, the distribution status of the distribution instruction information is updated to a different value. In this case, the result determination unit 409 updates the distribution status so as to be distinguishable from the update based on whether or not information on the installed firmware corresponds to the information on the firmware to be distributed as instructed by the distribution instruction information.

For example, the distribution instruction information may include a deemed determination flag in the server so that the same distribution status “completed” can be distinguished based on the presence or absence of the flag. In this case, the distribution instruction information has a flag indicating whether or not the update of the distribution status is an update based on the installation result notified by the notification unit.

In step S1305, the result determination unit 409 updates the distribution status of the corresponding distribution instruction information to “failed (deemed)” indicating a distribution failure. Here, the value of the error code included in the distribution instruction information may be updated to a value indicating that the distribution status has been determined as “failed (deemed)” by the result determination unit 409.

Note that even if the distribution status is “completed (deemed)” at the time of step S1207, for example when the processing of FIG. 13 is performed prior to step S1207, the result based on the installation completion notification information from the image forming apparatus 103 may be given priority and the status may be updated to “completed.” Setting the distribution status to “completed (deemed)” or “failed (deemed)” is an example of a provisional update to the distribution status. The update of the distribution status performed according to the result of the installation completion notification information from the image forming apparatus 103, in a case in which the distribution status is “completed (deemed),” is an example of a final update. In this case, the distribution status is overwritten by the final update.

As described above, according to the present embodiment, it is possible to distinguish between cases where the image forming apparatus 103 is a device that notifies installation results and cases where it is a device that does not notify installation results, even when both cases coexist.

### Third Embodiment

Next, a third embodiment of the present disclosure will be explained. In the third embodiment, only the portions that are different from the first embodiment are described. The third embodiment is an example in which the image forming apparatus 103 has a function of registering a distribution history, and in which a user can confirm a distribution status and a past distribution history by using the status confirmation unit 405 and the report generation unit 406 of the distribution management server 101. In the third embodiment, the distribution management server 101 generates distribution history information at the timing when processing is executed by the request processing unit 403, and causes the history management unit 407 to hold the information.

The distribution history information includes the following information.
Distribution history ID
History registration date
Event name
Device ID of the image forming apparatus 103
Corresponding distribution ID
Region
Identification information on a parent company to which the image forming apparatus 103 belongs
Processing result
Firmware ID registered in the device at the time of history registration
Distribution target firmware ID
   Hereinafter, each piece of information included in this distribution history information will be explained.

The distribution history ID is an ID that uniquely identifies the distribution history information. The history registration date is a description of the registration date of the distribution history identified by the distribution history ID. The event name is a description of the event name of the distribution history identified by the distribution history ID. The device ID of the image forming apparatus 103 is the device ID of the image forming apparatus 103 that is a target device of the distribution history identified by the distribution history ID. The corresponding distribution ID is the distribution ID of the distribution that is the target of the distribution history identified by the distribution history ID. The region is a description of the region of the distribution history identified by the distribution history ID. The identification information on the parent company to which the image forming apparatus 103 belongs is the identification information on the parent company to which the image forming apparatus 103, which is a target device of the distribution history identified by the distribution history ID, belongs. The processing result is a result of processing the target distribution of the distribution history identified by the distribution history ID. The firmware ID registered in the device at the time of history registration is the firmware ID of the firmware registered in the target device of the distribution history identified by the distribution history ID at the time of history registration. The distribution target firmware ID is the firmware ID of the firmware to be distributed in the distribution identified by the distribution history identified by the distribution history ID.

Here, further explanation is provided regarding the event name. The event name is information for identifying the timing at which the distribution history information is written. The timing at which the distribution history information is written may include, for example, the following timings.
A timing at which distribution instruction information is generated in response to an instruction from the client PC 104 through the operation screen providing unit 402
A timing at which distribution instruction information is generated in response to a request from the image forming apparatus 103
A timing at which the image forming apparatus 103 attempts to acquire download target firmware information
A timing at which the image forming apparatus 103 completes downloading
A timing at which the image forming apparatus 103 starts installation of the firmware
A timing at which a firmware installation completion notification is performed by the image forming apparatus 103
A timing at which the result determination unit 409 of the distribution management server 101 performs determination

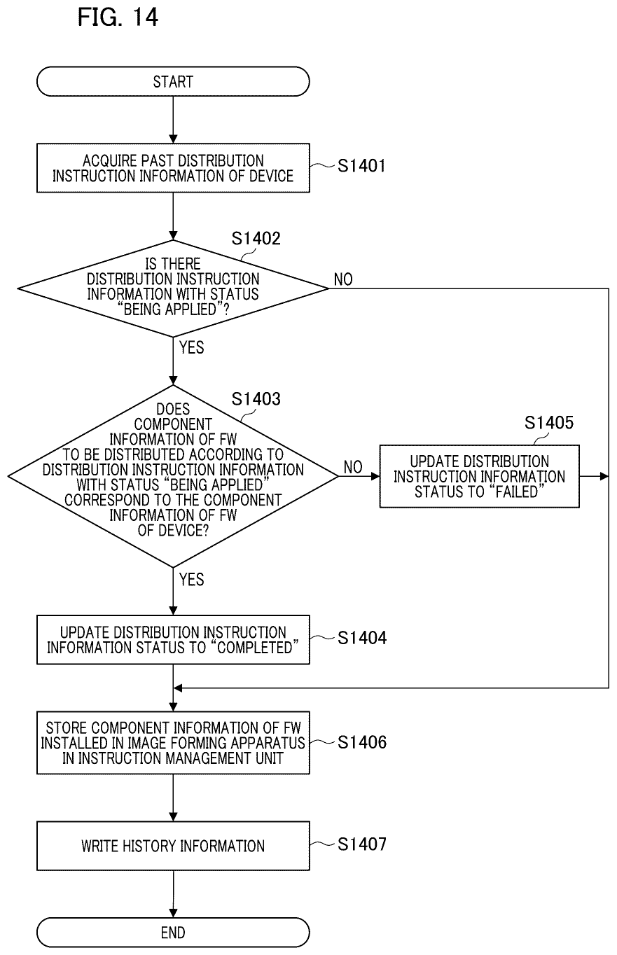

FIG. 14 is a diagram illustrating a processing flow in the result determination unit 409 of the distribution management server 101 according to the third embodiment. The flow in FIG. 14 is performed asynchronously with the firmware distribution in FIG. 10, similarly to the flow in FIG. 11 according to the first embodiment. Since the processing in steps S1401 to S1406 is similar to those in steps S1101 to S1106 of the first embodiment, the explanation thereof will be omitted.

After the statuses are updated by the processes in steps S1404 and S1405, the result determination unit 409 generates distribution history information in step S1407 and holds it in the history management unit 407.
The history management unit 407 holds, for example, the following distribution history information.

```
{
  “historyId”: “1234”,
  “registeredDate”: “2024/04/19 09:00:00”,
  “eventName”: “updateEndByServer”,
  “deviceId”: “AAA00001”,
  “deliveryId”: “1”,
  “region”: “JP”,
  “TenantId”: “A”,
  “resultCode”: “00000001”,
  “installedFirmwareId”: “0”,
  “targetfirmwareId”: “1”
}
```

The event name of the distribution history information generated in the processing of step S1407 may be distinguished so as to accommodate the case in which distribution history information is generated in response to a firmware installation completion notification from the image forming apparatus 103, as in the second embodiment. For example, the event name of the distribution history information generated in the processing of step S1404 may be set to “eventName”: “updateEndByServer”. In contrast, the event name of the distribution history information generated when the firmware installation completion notification is notified may be set to, for example, “eventName”: “updateEndByDevice”.

Additionally, the event name of the distribution history information may be set as follows. In the case in which the image forming apparatus 103 does not send a firmware installation end notification, as in the first embodiment, the event name of the distribution history information may be set to “eventName”: “updateEnd”. Additionally, as in the second embodiment, even if the image forming apparatus 103 sends a firmware installation completion notification, if there is no need to distinguish the event name of the distribution history information generated at that time, the event name may be set to “eventName”: “updateEnd”.

Alternatively, by notifying the distribution history information to an external server that monitors the distribution management server 101, a report may be generated by the report generation function of the external server.

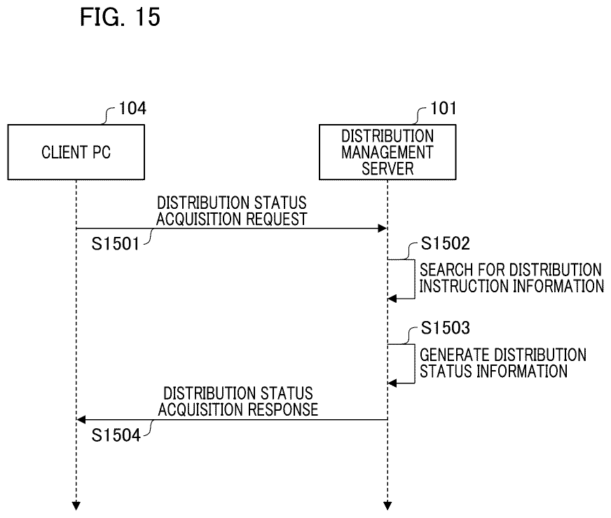

FIG. 15 is a diagram illustrating a sequence in which a user confirms the latest distribution instruction information using the status confirmation unit 405 according to the third embodiment. The sequence of FIG. 15 begins when the user transmits a distribution status acquisition request to the distribution management server 101 via the client PC 104 from the UI provided by the operation screen providing unit 402 of the distribution management server 101.

In step S1501, the distribution management server 101 receives a distribution status acquisition request from the client PC 104. Upon receiving the distribution status acquisition request, the status confirmation unit 405 of the distribution management server 101 performs subsequent processing based on the distribution status acquisition detailed information included in the received distribution status acquisition request.

The distribution status acquisition detailed information may include the following information:
Output format
Device ID of the image forming apparatus 103 that is an output target
   Hereinafter, information included in this distribution status acquisition detailed information will be explained.

The output format may include information indicating display on the UI or information indicating output in a report format such as a CSV file. CSV is an abbreviation for “Comma Separated Values.” Additionally, FIG. 15 explains an example in which the display on the UI and the report format are switched according to the value of the output format of the distribution status acquisition detailed information, although the output format may alternatively be switched by preparing different UIs without designating the output format.

In step S1502, the status confirmation unit 405 acquires the latest distribution instruction information corresponding to the device ID of the image forming apparatus 103 to be output included in the received distribution status acquisition detailed information from the instruction management unit 408. Here, in the search for the latest distribution instruction information, the latest generation time of the distribution instruction information included in the distribution instruction information may be a target, or in a case in which the distribution ID gradually increases in a serial number, the distribution instruction information having the largest distribution ID value may be a target.

In step S1503, the status confirmation unit 405 generates distribution status information based on the distribution instruction information acquired in step S1502 and the distribution status detailed information received in step S1501. Here, as the output format of the distribution status acquisition detailed information, in a case in which information indicating display on the UI is received, the distribution status information may be generated in a file format that can be confirmed on the UI. Additionally, in a case in which information indicating that the distribution status acquisition detailed information is output in a report format as an output format is received, the distribution status information may be generated in a CSV file and the like, and a link and the like through which the generated file can be downloaded may be generated.

The distribution status information is generated by acquiring, for example, the following information from the distribution instruction information.
Distribution status
Distribution target firmware ID
Distribution target device ID
Creator of distribution instruction information
Method of installation
Download execution time
Installation execution time
Error code

Here, as in the second embodiment, if statuses indicating distribution completion such as “completed” and “completed (deemed)” coexist in the distribution status of the distribution instruction information, these may be unified and updated to be displayed simply as “completed.”

In step S1504, the status confirmation unit 405 returns a distribution status acquisition response to the client PC 104. In a case in which information indicating display on the UI is specified in the output format of the distribution status acquisition detailed information, it is sufficient to return a file format that can be confirmed on the UI as a distribution status acquisition response, and to confirm the distribution status on the UI from the client PC 104. Additionally, in a case in which information indicating output in a report format such as a CSV file is specified in the output format of the distribution status acquisition detailed information, a link for downloading the CSV file is returned as a distribution status acquisition response. The user can download the CSV file by accessing the link and confirm the distribution status on the client PC 104.

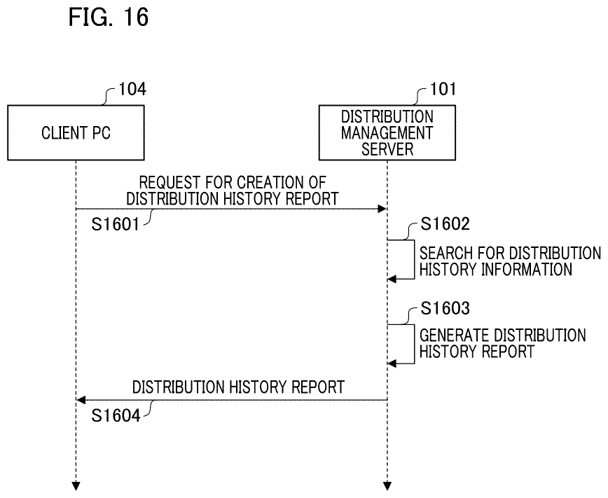

FIG. 16 illustrates a sequence in which the report generation unit 406 according to the third embodiment generates a distribution history report. The sequence of FIG. 16 is started when the user transmits a distribution history report generation request to the distribution management server 101 from the UI provided by the operation screen providing unit 402 of the distribution management server 101 via the client PC 104.

In step S1601, the distribution management server 101 receives a distribution history report generation request from the client PC 104. The report generation unit 406 of the distribution management server 101 that has received the distribution history report generation request performs the following processing based on the distribution history report generation request information included in the received distribution history report generation request.

The distribution history report generation request information may include the following information:
Report Type
Device ID of the image forming apparatus 103 that is an output target
Distribution target firmware ID of distribution history information to be output
Generation period of distribution history information to be output

As the report type, for example, the following reports may be designated to be output:
A report on outputting distribution history information
A report for outputting a list of the number of image forming apparatuses 103 for which update of firmware distribution has been completed
A report for outputting a list of the number of image forming apparatuses 103 for which update of firmware distribution has been completed for each installation method and distribution instruction information generation method
A report for outputting a list of device IDs of the image forming apparatuses 103 in which the firmware has been updated

In step S1602, the report generation unit 406 searches for target distribution history information based on the received distribution history report generation request. In step S1603, the report generation unit 406 generates a distribution history report using the searched distribution history information. Finally, in step S1604, the report generation unit 406 returns the generated distribution history report to the client PC 104. Here, the distribution management server 101 may directly return the generated distribution history report to the client PC 104, or may issue a URL for downloading and return the URL so that the distribution history report can be downloaded.

As described above, according to the present embodiment, the user can confirm information related to the distribution for the image forming apparatus 103.

It should be noted that, in each of the first to third embodiments, the number of servers and the number of image forming apparatuses are not necessarily the same as those in the overall configuration illustrated in FIG. 1.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to check an update result of firmware at a remote location.

This application claims the benefit of Japanese Patent Application No. 2024-140057, filed Aug. 21, 2024, which is hereby incorporated by reference wherein in its entirety.

What is claimed is:

1. A system that includes an image processing apparatus and a distribution management server configured to manage distribution of firmware operating on the image processing apparatus,
the image processing apparatus comprising:
a first memory storing first instructions; and
a first processor executing the stored first instructions causing the image processing apparatus to:
distribute distribution target firmware instructed by distribution instruction information from the image processing apparatus to the image processing apparatus;
the distribution management server comprising:
a second memory storing second instructions; and
a second processor executing the stored second instructions causing the distribution management server to:
acquire information on firmware installed in the image processing apparatus; and
update, without receiving an update result of distribution target firmware instructed by the distribution instruction information from the image processing apparatus and based on whether or not information on the installed firmware corresponds to information on distribution target firmware instructed by the distribution instruction information, a distribution status serving as a distribution result of distribution target firmware instructed by the distribution instruction information.

2. The system according to claim 1,
wherein the first processor further executes the first instructions causing the image processing apparatus to notify the distribution management server of an installation result of distributed firmware,
wherein the second processor further executes the second instructions causing the distribution management server to update the distribution status based on the notified installation result, and
wherein the distribution instruction information has a flag indicating whether or not the update of the distribution status is an update based on the notified installation result.

3. The system according to claim 1,
wherein the first processor further executes the first instructions causing the image processing apparatus to notify the distribution management server of an installation result of distributed firmware, and
wherein the second processor further executes the second instructions causing the distribution management server to update the distribution status based on the notified installation result so as to be distinguishable from the update of the distribution status based on whether or not information on the installed firmware and information on distribution target firmware instructed by the distribution instruction information correspond.

4. The system according to claim 1,
wherein the first processor further executes the first instructions causing the image processing apparatus to notify the distribution management server of an installation result of distributed firmware, and
wherein the second processor further executes the second instructions causing the distribution management server to perform a provisional update of the distribution status based on whether or not information on the installed firmware and information on distribution target firmware instructed by the distribution instruction information correspond, and to overwrite the distribution status with a final update based on the notified installation result.

5. A method for a system that includes an image processing apparatus and a distribution management server configured to manage distribution of firmware that operates on the image processing apparatus, the method comprising:
distributing distribution target firmware instructed by distribution instruction information from the image processing apparatus to the image processing apparatus;
acquiring information on firmware installed in the image processing apparatus by the distribution management server; and
updating, without receiving an update result of distribution target firmware instructed by the distribution instruction information from the image processing apparatus and based on whether or not information on the installed firmware and information on distribution target firmware instructed by the distribution instruction information correspond, a distribution status serving as a distribution result of distribution target firmware instructed by the distribution instruction information.
